(19) United States
(12) Patent Application Publication
(10) Pub. No.: US 2025/0215916 A1
(43) Pub. Date: Jul. 3, 2025

(54) FASTENER STRUCTURALLY CONFIGURED TO SECURE AN ELECTRONIC COMPONENT IN AN ENCLOSURE QUICKLY WITHOUT USING TOOLS TO ENHANCE EFFICIENCY AND SIMPLICITY

(71) Applicant: PPC BROADBAND, INC., East Syracuse, NY (US)

(72) Inventors: Cameron James ADAMS, Camillus, NY (US); Brian K HANSON, Cicero, NY (US); Maximillian MARCHIOLI, Syracuse, NY (US); Chris SHYNE, Manlius, NY (US)

(73) Assignee: PPC BROADBAND, INC., East Syracuse, NY (US)

(21) Appl. No.: 19/006,407

(22) Filed: Dec. 31, 2024

Related U.S. Application Data
(60) Provisional application No. 63/616,714, filed on Dec. 31, 2023.

(51) Int. Cl. F16B 19/10; F16B 19/12

(52) U.S. Cl. CPC F16B 19/109; F16B 19/12

(57) ABSTRACT

A fastener structurally configured to secure an electronic component in an enclosure without using tools during installation to provide enhanced installation efficiency and simplicity. The fastener may include a housing portion having a plunger receiving portion, a plunger portion configured to be received in the plunger receiving portion, a biasing portion configured to be received on a distal end portion of the plunger portion, and an operating portion configured to be coupled with the plunger portion such that movement of the operating portion from a first position to a second position results in relative movement between the plunger portion and the plunger receiving portion such that the biasing portion is axially compressed and radially expanded so as to secure an electronic component in the enclosure.

### RELATED APPLICATIONS

The present application claims the benefit of U.S. Provisional Patent Application No. 63/616,714, filed Dec. 31, 2023, the entire disclosure of which is herein fully incorporated by reference.

### TECHNICAL FIELD

The present disclosure generally relates to fasteners and, more particularly, to fasteners structurally configured to secure an electronic component in an enclosure quickly while eliminating the need for tools during installation.

### BACKGROUND

Installation of cable service requires some transmission lines and other electronic equipment to remain outdoors, housed within an enclosure, such as a cable box shield. The enclosure is typically externally mounted to a structure, such as a dwelling, an office building, or a pole. Housing the transmission lines and other electronic equipment within the externally mounted enclosure allows a technician to service a location, often times without the need to enter a consumer's home or office, by accessing the housed transmission lines and other equipment.

Conventional enclosures for telecommunications have areas where the necessary electronic components, for example, amplifiers, splitters, etc., are mounted inside via screws. This can be a time-consuming task that many times is ignored all together, for example, if a technician does not have the tool needed to secure the electronic component with the screw. As a result, electronic components may be left “floating” inside the enclosure rather than being fastened down.

In cases where screws are threaded into screw bosses to secure the electronic component in the enclosure, removal of the screw again requires a technician to carry the requisite tool for removing the screw. Additionally, screwing and unscrewing the screw relative to a plastic boss often renders that boss non-reusable, thus requiring the technician to rearrange the electronic components in the enclosure.

It may therefore be desirable to make the installation of hardware, for example, electronic components, within the enclosure less time-consuming and burdensome by removing the need for screws and the associated tools. For example, it may be desirable to provide a toolless fastener that is configured to secure an electronic component in an enclosure quickly and without tools to provide enhanced installation.

### SUMMARY

In accordance with an exemplary embodiment of the disclosure, a fastener may be structurally configured to secure an electronic component in an enclosure without using tools during installation is provided to enhance efficiency and simplicity.

In some embodiments, the fastener may include a housing portion having a flange portion and a plunger receiving portion and an actuating portion coupled with the housing portion.

In some embodiments, the flange portion may include an engagement surface portion structurally configured to engage a mounting surface portion of an electronic component.

In some embodiments, the actuating portion may include a plunger portion slidingly received in the plunger receiving portion.

In some embodiments, the plunger portion may have a distal end portion extending out from the plunger receiving portion and a proximal end portion opposite the distal end portion.

In some embodiments, the actuating portion may include a camming portion pivotally coupled with the proximal end portion of the plunger portion.

In some embodiments, the distal end portion of the plunger portion may include a flanged portion having a cross sectional dimension greater than a cross sectional dimension of the plunger receiving portion.

In some embodiments, the actuating portion may include a biasing portion received on the plunger portion between the flanged portion of the distal end portion of the plunger portion and a distal end portion of the plunger receiving portion.

In some embodiments, the biasing portion may have a larger cross sectional dimension than a cross sectional dimension of a passage of the plunger receiving portion such that the biasing portion is prevented from entering the passage.

In some embodiments, the biasing portion may be configured to be positioned between a biasing portion engaging surface of the plunger receiving portion and a biasing portion engaging surface of the plunger portion.

In some embodiments, the biasing portion may be structurally configured to be compressed in an axial direction between the biasing portion engaging surface of the plunger receiving portion and the biasing portion engaging surface of the plunger portion such that the biasing portion expands in a radially outward direction.

In some embodiments, the camming portion may be configured to be pivotally coupled with the plunger portion at a pivot portion.

In some embodiments, the camming portion may be structurally configured to be moved between a first position and a second position.

In some embodiments, the camming portion may include a camming surface portion configured to engage a cam engaging surface portion of the plunger receiving portion such that when the camming portion moves from the first position to the second position, an engagement between the camming surface portion and the cam engaging surface portion of the plunger receiving portion results in relative sliding movement between the plunger portion and the plunger receiving portion of the housing portion such that the biasing portion is axially compressed and radially expanded so as to secure an electronic component in an enclosure and provide enhanced installation efficiency and simplicity.

In some embodiments, the camming portion may include a retaining portion structurally configured to retain the camming portion in the first position and the second position.

In some embodiments, the retaining portion may include a first grooved surface portion configured to receive the plunger portion when the camming portion is in the first position such that a user is required to apply a force to remove the plunger portion from the first grooved surface portion in order to move the camming portion out of the first position.

In some embodiments, the retaining portion may include a second grooved surface portion configured to receive the plunger portion when the camming portion is in the second position such that a user is required to apply a force to remove the plunger portion from the second grooved surface portion in order to move the camming portion out of the second position.

In some embodiments, the camming portion may include a lever portion structurally configured to be manually actuated to pivot the camming portion.

In some embodiments, a fastener may be structurally configured to secure an electronic component in an enclosure without using tools during installation. In some embodiments, fastener may include a housing portion including an engagement surface portion and a plunger receiving portion, a plunger portion slidingly received in the plunger receiving portion, a biasing portion received on a distal end portion of the plunger portion, and a camming portion pivotally coupled with a proximal end portion of the plunger portion to pivot between a first position and a second position.

In some embodiments, the engagement surface portion may be structurally configured to engage an electronic component to secure the electronic component to an enclosure.

In some embodiments, the biasing portion may be structurally configured to be compressed in an axial direction between the plunger receiving portion and a biasing portion engaging surface at the distal end portion of the plunger portion such that the biasing portion expands in a radially outward direction.

In some embodiments, the camming portion may include a camming surface portion configured to engage a cam engaging surface portion of the plunger receiving portion such that when the camming portion moves from the first position to the second position, an engagement between the camming surface portion and the cam engaging surface portion of the plunger receiving portion results in relative movement between the plunger portion relative to the plunger receiving portion such that the biasing portion is axially compressed and radially expanded so as to secure an electronic component in an enclosure and provide enhanced installation efficiency and simplicity.

In some embodiments, the camming portion may include a lever portion structurally configured to be manually actuated to pivot the camming portion.

In some embodiments, the fastener may include a retaining portion structurally configured to retain the camming portion in the first position and the second position. In some embodiments, the retaining portion may include a first grooved surface portion configured to receive the plunger portion when the camming portion is in the first position such that a user is required to apply a force to remove the plunger portion from the first grooved surface portion in order to move the camming portion out of the first position. In some embodiments, the retaining portion may include a second grooved surface portion configured to receive the plunger portion when the camming portion is in the second position such that a user is required to apply a force to remove the plunger portion from the second grooved surface portion in order to move the camming portion out of the second position.

In some embodiments, the distal end portion of the plunger portion may include a flanged portion having a cross-sectional dimension greater than a cross sectional dimension of the plunger receiving portion.

In some embodiments, the biasing portion may be received in the plunger portion between the flanged portion and the plunger receiving portion.

In some embodiments, a fastener may be structurally configured to secure an electronic component in an enclosure without using tools during installation. In some embodiments, the fastener may include a housing portion including an engagement surface portion and a plunger receiving portion, a plunger portion configured to be received in the plunger receiving portion, a biasing portion configured to be received on a distal end portion of the plunger portion, and an operating portion configured to be coupled with the plunger portion.

In some embodiments, the engagement surface portion may be structurally configured to engage an electronic component to secure the electronic component to an enclosure.

In some embodiments, the biasing portion may be structurally configured to be compressed in an axial direction between the plunger receiving portion and a biasing portion engaging surface at the distal end portion of the plunger portion such that the biasing portion expands in a radially outward direction.

In some embodiments, movement of the operating portion from a first position to a second position may result in relative movement between the plunger portion and the plunger receiving portion such that the biasing portion is axially compressed and radially expanded so as to secure an electronic component in the enclosure and provide enhanced installation efficiency and simplicity.

In some embodiments, the operating portion may include a camming portion pivotally coupled with a proximal end portion of the plunger portion to pivot between the first position and the second position.

In some embodiments, the camming portion may include a camming surface portion configured to engage a cam engaging surface portion of the plunger receiving portion such that when the camming portion moves from the first position to the second position, an engagement between the camming surface portion and the cam engaging surface portion of the plunger receiving portion results in relative the movement between the plunger portion relative to the plunger receiving portion.

In some embodiments, the camming portion may include a lever portion structurally configured to be manually actuated to pivot the camming portion.

In some embodiments, the operating portion may include a first ramped portion fixed relative to the housing portion and a second ramped portion fixed relative to the plunger portion.

In some embodiments, rotation of the first ramped portion relative to the second ramped portion may move\ the plunger portion to radially compress the biasing portion.

In some embodiments, the fastener may include retaining portion structurally configured to retain the operating portion in the first position and in the second position.

In some embodiments, the distal end portion of the plunger portion may include a flanged portion having a cross sectional dimension greater than a cross sectional dimension of the plunger receiving portion.

In some embodiments, the biasing portion may be received in the plunger portion between the flanged portion and the plunger receiving portion.

In some embodiments, the biasing portion may have a larger cross sectional dimension than a cross sectional dimension of a passage of the plunger receiving portion such that the biasing portion is prevented from entering the passage.

### BRIEF DESCRIPTION OF THE DRAWINGS

Further advantages and features of the present disclosure will become apparent from the following description and the accompanying drawings, to which reference is made. In which are shown:

FIG. 1 is an isometric view of an exemplary toolless fastener in an unactuated state in accordance with various aspects of the disclosure.

FIG. 2 is an isometric view of the exemplary toolless fastener of FIG. 1 in an actuated state.

FIG. 3 is a side cross sectional view of the exemplary toolless fastener of FIG. 1 in an unactuated state.

FIG. 4 is a side cross sectional view of the exemplary toolless fastener of FIG. 1 in an actuated state.

FIG. 5 is a side cross sectional view of the exemplary toolless fastener of FIG. 1 in an unactuated state before securing an amplifier with an enclosure.

FIG. 6 is a side cross sectional view of the exemplary toolless fastener of FIG. 1 in an actuated state securing an amplifier in an enclosure.

FIG. 7 is an isometric view of the exemplary toolless fastener of FIG. 1 in an unactuated state before securing an amplifier with an enclosure.

FIG. 8 is an isometric view of the exemplary toolless fastener of FIG. 1 in an actuated state securing an amplifier in an enclosure.

FIG. 9 is a side cross sectional view of the exemplary toolless fastener of FIG. 1 in an unactuated state before securing a splitter with an enclosure.

FIG. 10 is a side cross sectional view of the exemplary toolless fastener of FIG. 1 in an actuated state securing a splitter in an enclosure.

FIG. 11 is an isometric view of the exemplary toolless fastener of FIG. 1 in an unactuated state before securing a splitter with an enclosure.

FIG. 12 is an isometric view of the exemplary toolless fastener of FIG. 1 in an actuated state securing a splitter in an enclosure.

FIG. 13 is an isometric view of another exemplary toolless fastener in an unactuated state in accordance with various aspects of the disclosure.

FIG. 14 is an isometric view of another exemplary toolless fastener in an unactuated state in accordance with various aspects of the disclosure.

FIG. 15 is an isometric view of another exemplary toolless fastener in an unactuated state in accordance with various aspects of the disclosure.

FIG. 16 is an isometric view of another exemplary toolless fastener in accordance with various aspects of the disclosure.

FIG. 17 is an isometric view of another exemplary toolless fastener in accordance with various aspects of the disclosure.

FIG. 18 is an isometric view of another exemplary toolless fastener in a first configuration in accordance with various aspects of the disclosure.

FIG. 19 is an isometric view of another exemplary toolless fastener of FIG. 18 in a second configuration.

### DETAILED DESCRIPTION

Reference will now be made in detail to embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

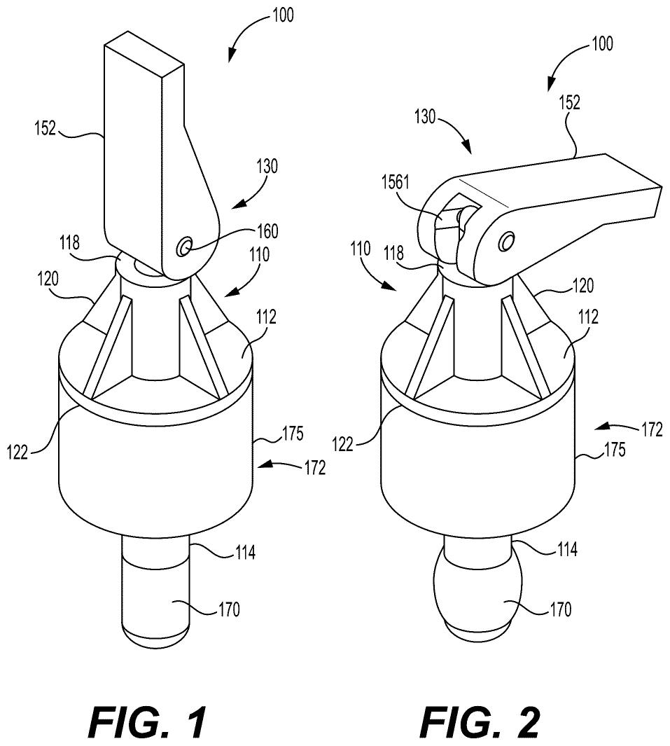

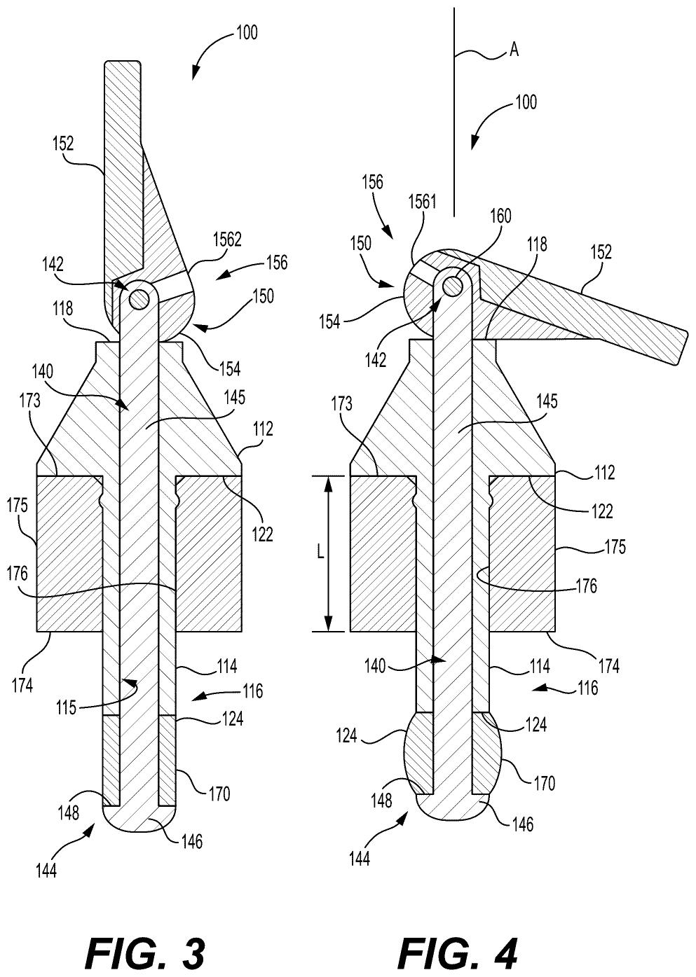

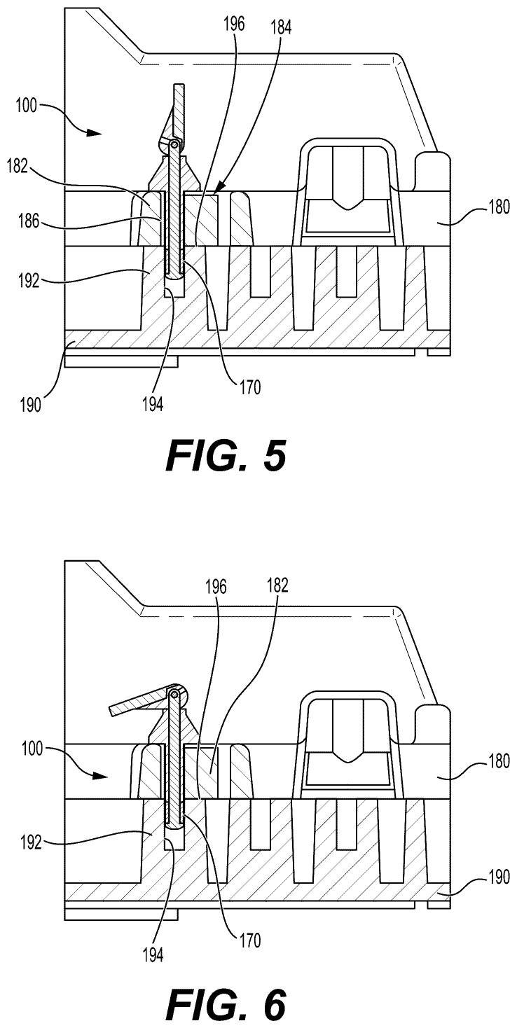

Referring to FIGS. 1-4, an exemplary fastener 100 in accordance with various aspects of the disclosure. In some embodiments, the fastener 100 may be structurally configured to secure an electronic component 180 in an enclosure 190 (FIG. 5) quickly while eliminating the need for tools during installation. In some embodiments, the fastener 100 may include a housing portion 110 and an actuating portion 130.

The housing portion 110 may be configured in a variety of ways. In some embodiments, the housing portion 110 may include a flange portion 112 and a plunger receiving portion 114 that extends from the flange portion 112 in two directions. In a first direction, the plunger receiving portion 114 may extend to a distal end portion or free end portion 116. In a second direction, the plunger receiving portion 114 may extend to a cam engaging surface portion 118. In some embodiments, the plunger receiving portion 114 may be cylindrical with a through passage 115 (e.g., a through bore). In other embodiments, the plunger receiving portion 114 may be shaped other than cylindrical.

In some embodiments, the housing portion 110 may include a strengthening portion 120 to add structural strength to the fastener 100. The strengthening portion 120 may be configured in a variety of ways. In some embodiments, the strengthening portion 120 may include one or more weblike structures (e.g., fins, stabilizer, etc.) tapering from the flange portion 112 toward the cam engaging surface portion 118 of the plunger receiving portion 114. In some embodiments, the flange portion 112 may include an engagement surface 122 structurally configured to engage a mounting surface portion 184 of a mounting portion 182 of the electronic component 180 (FIG. 5).

In some embodiments, the actuating portion 130 may include a plunger portion 140, an operating portion 149, and a biasing portion 170. The plunger portion 140 may be configured in a variety of way. In some embodiments, the plunger portion 140 may be sized and configured to extend through the passage 115 of the plunger receiving portion 114. In some embodiments, the plunger portion 140 may be structurally configured to be slidingly moved relative to the plunger receiving portion 114.

In some embodiments, the plunger portion 140 may have a first end portion 142, a second end portion 144 opposite the first end portion 142, and an elongated body portion 145 (e.g., a rod, cylinder, tube, shaft, etc.) extending between the first end portion 142 and the second end portion 144 along an axis A (FIG. 4). In some embodiments, the first end portion 142 may be structurally configured to be coupled with operating portion 149. In some embodiments, the second end portion 144 may extend from the distal end portion 116 of the plunger receiving portion 114. In some embodiments, the second end portion 144 may include a flanged portion 146 that has a larger cross-sectional dimension (e.g., diameter) than a cross-sectional dimension (e.g., diameter) of the passage 115 of the plunger receiving portion 114 such that the flanged portion 146 cannot enter the passage 115.

In some embodiments, the biasing portion 170 may be disposed between the flanged portion 146 of the second end portion 144 of the plunger portion 140 and the distal end portion 116 of the plunger receiving portion 114. In some embodiments, the biasing portion 170 may have a larger cross-sectional dimension than the cross-sectional dimension of the passage 115 of the plunger receiving portion 114 such that the biasing portion 170 cannot enter the passage 115. As a result, the biasing portion 170 may be positioned between a biasing portion engaging surface 124 of the plunger receiving portion 114 and a biasing portion engaging surface 148 of the plunger portion 140.

The biasing portion 170 may be configured in a variety of ways. In some embodiments, the biasing portion 170 may include an elastomeric material such as, for example, a rubber gland, that may be structurally configured to be compressed in an axial direction between the biasing portion engaging surface 124 of the plunger receiving portion 114 and the biasing portion engaging surface 148 of the plunger portion 140. When axially compressed, the biasing portion 170 may expand in a radially outward direction.

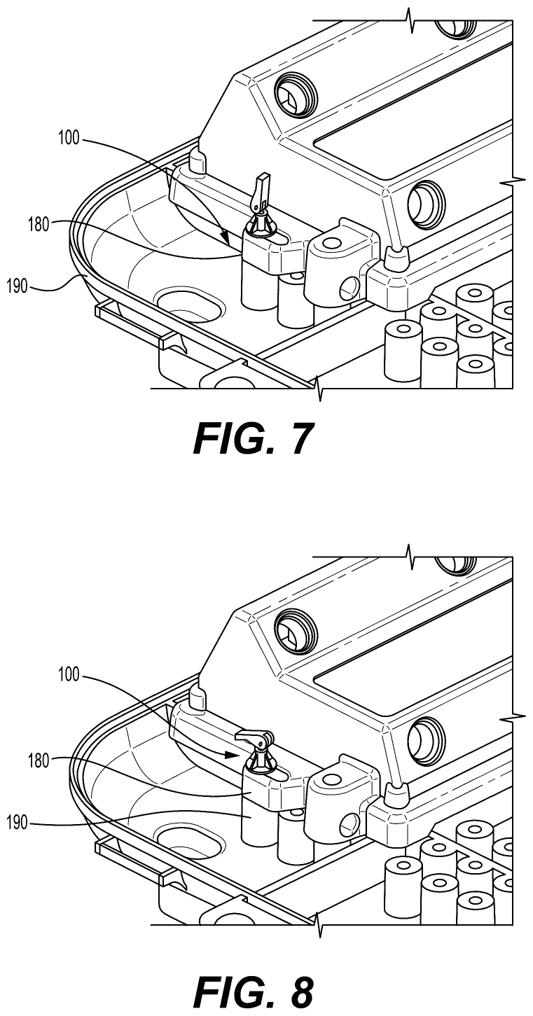

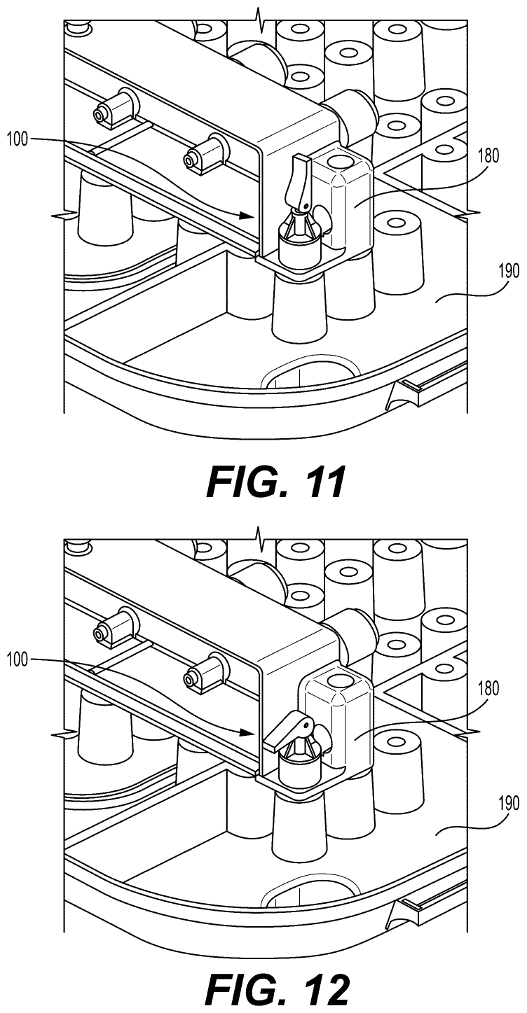

The operating portion 149 may be structurally configured to be manually operated to actuate the fastener 100. The operating portion 149 may be configured in a variety of ways. In some embodiments, the operating portion 149 may include a camming portion 150 pivotally coupled with the first end portion 142 of the plunger portion 140 at a pivot portion 160 (e.g., a pivot pin). In some embodiments, the camming portion 150 may be structurally configured to be moved between a first position, for example, an unactuated position, as shown in FIGS. 1, 3, 5, 7, 9, and 11, and a second position, for example, an actuated position, as shown in FIGS. 2, 4, 6, 8, 10, and 12. In some embodiments, the camming portion 150 may include a lever portion 152 structurally configured to be gripped by a user. In some embodiments, the camming portion 150 may include a retaining portion 156 configured to retain the camming portion 150 in first position and the second position. For example, the retaining portion 156 may include a first grooved surface portion 1561 (e.g., a radially extending groove(s)) configured to receive the first end portion 142 of the plunger portion 140 when the camming portion 150 is in the first position such that a user is required to apply a force to remove the plunger portion 140 from the first grooved surface portion 1561 in order to move the camming portion 150 out of the first position. Similarly, the retaining portion 156 may include a second grooved surface portion 1562 (e.g., a radially extending groove(s)) configured to receive the first end portion 142 of the plunger portion 140 when the camming portion 150 is in the second position such that a user is required to apply a force to remove the plunger portion 140 from the second grooved surface portion 1562 in order to move the camming portion 150 out of the second position. Thus, in some embodiments, the retaining portion 156 acts as a detent.

In some embodiments, the camming portion 150 may have a camming surface portion 154 structurally configured to engage the cam engaging surface portion 118 of the plunger receiving portion 114. In some embodiments, the camming surface portion 154 may comprise a curved peripheral portion of the camming portion 150. In some embodiments, the pivot portion 160 may be disposed asymmetrically relative to the curved camming surface portion 154 such that when the camming portion 150 is moved from the first position to the second position, the engagement between the camming surface portion 154 and the cam engaging surface portion 118 may result in relative sliding movement between the plunger portion 140 and the plunger receiving portion 114 of the housing portion 110. Particularly, the plunger portion 140 may move relative to the plunger receiving portion 114 such that the flanged portion 146 moves toward the distal end portion 116 of the plunger receiving portion 114, thereby axially compressing the biasing portion 170 and radially expanding the biasing portion 170.

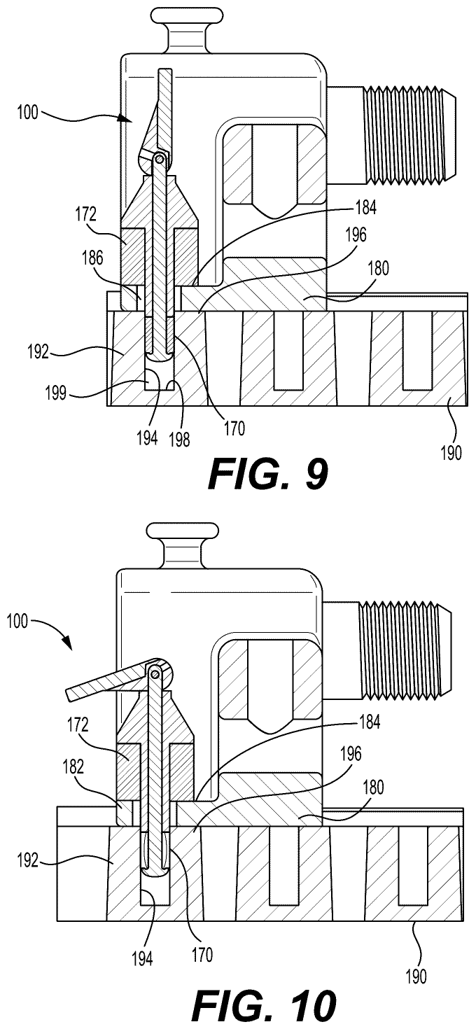

In some embodiments, the fastener 100 may include an optional spacing portion or spacer 172 structurally configured to be positioned between the engagement surface 122 of the flange portion 112 and the electronic component 180 to space the fastener 100 a distance away from the electronic component 180 in some applications, as shown in FIG. 9-12. The spacing portion 172 may be configured in a variety of ways, including shape and size. In some embodiments, the spacing portion 172 may be cylindrical. In other embodiments, however, the spacing portion 172 may be any suitable shape.

In some embodiments, the spacing portion 172 may include a first end surface portion 173, and second end surface portion 174 opposite the first end surface portion 173, and a sidewall portion 175 having a length L (FIG. 4) extending between the first end surface portion 173 and the second end surface portion 174. In some embodiments, the spacing portion 172 may include a passage 176 structurally configured to receive the plunger receiving portion 114.

Referring to FIGS. 5-12, the fastener 100 is shown after insertion through a bore 186 of an electronic component 180 and into a receiving portion 192, for example, a screw boss, of an enclosure 190. As shown in FIGS. 6 and 10, when the biasing portion 170 is disposed in the receiving portion 192 of the enclosure 190, movement of the camming portion 150 from the first, unactuated position to the second, actuating position urges the biasing portion 170 against the inner walls 194 of the receiving portion to secure the fastener 100 to the enclosure 190. With the mounting portion 182 of the electronic component 180 secured between the flange portion 112 of the housing portion 110 and a component engaging surface portion 196 of the enclosure 190, the fastener 100 may secure the electronic component 180 to the enclosure 190.

As shown in FIGS. 5-9, in some applications, the spacing portion 172 may not be used when securing the electronic component 180 to the enclosure 190. As shown in FIGS. 6-10, however, in some applications, the spacing portion 172 may be used when securing the electronic component 180 to the enclosure 190. For example, when the mounting portion 182 of the electronic component 180 is thin enough that the first end portion 142 of the plunger portion 140 may bottom out in the enclosure 190 (e.g., contact a bottom surface 198 of a bore 199 of the receiving portion 192), the spacing portion 172 may be placed between the flange portion 112 and the mounting surface portion 184 of the electronic component 180 with the plunger receiving portion 114 received through the passage 176. As a result, the first end portion 142 of the plunger portion 140 may be spaced apart from the bottom surface 198 of the bore 199 of the receiving portion 192 and the fastener 100 may properly secure the electronic component 180 to the enclosure 190.

To remove the electronic component 180 from the enclosure 190, the camming portion 150 may be moved from the second, actuating position to the first, unactuated position, thereby releasing the biasing portion 170 from the inner walls 194 of the receiving portion. The fastener 100 can then be removed from the receiving portion 192 of the enclosure 190, thereby permitting the electronic component 180 to be removed from the enclosure 190.

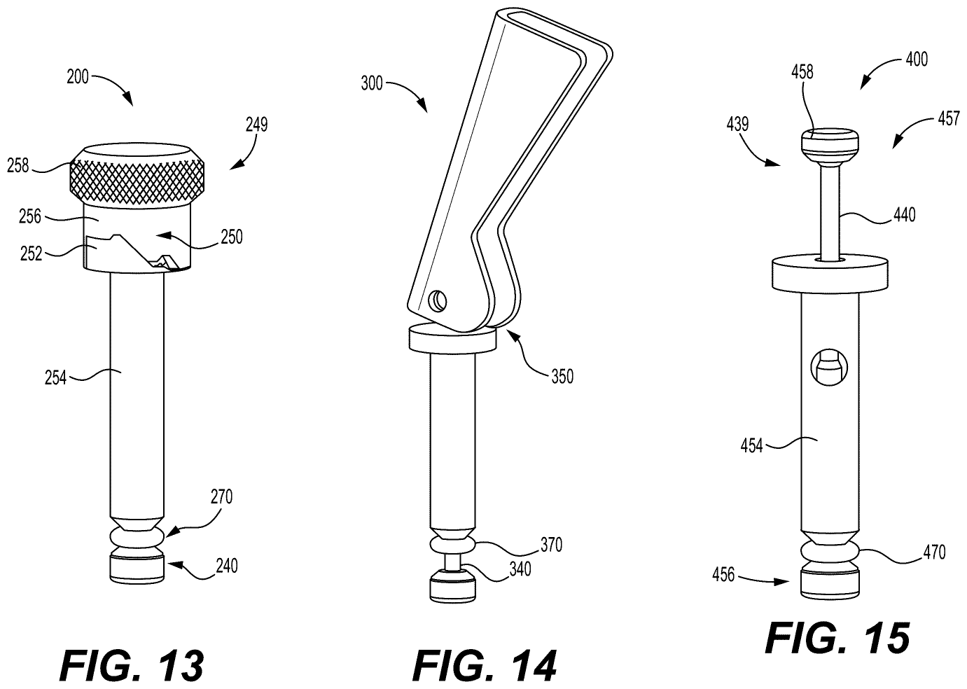

FIGS. 13-15 illustrate alternative embodiments of fasteners 200, 300, 400 structurally configured to couple an electronic component 180 to an enclosure 190. The fasteners 200, 300, 400 are structurally and functionally similar to the fastener 100 and, thus, the detailed discussion of the fastener 100 generally applies to fasteners 200, 300, 400, except for the following different details.

The fastener 200 illustrated in FIG. 13 may include, in some embodiments, an operating portion 249 having a ramped camming portion 250 rather than a curved camming portion 150 as with fastener 100. Otherwise, the fastener 200 may include a similar plunger portion 240 and biasing portion 270. For example, in some embodiments, the operating portion 249 may include a first ramped portion 252 fixed relative to a housing portion 254 that receives the plunger portion 240 and a second ramped portion 256 fixed relative to the plunger portion 240. In some embodiments, the operating portion 249 may include manually engagable portion 258 (e.g., a knob portion) fixed relative to the second ramped portion 256. In some embodiments, rotation of the manually engagable portion 258 may cause the second ramped portion 256 to engage the first ramped portion 252 in a manner that causes the plunger portion 240 to move axially relative to the housing portion 254 axially compressing the biasing portion 270. Thus, rotation of the manually engagable portion 258 moves the fastener 200 between the unactuated and actuated states. In some embodiments, the ramped portions 252, 256 may be structurally configured to hold the fastener 200 in the actuated state until released by manually rotating the manually engagable portion 258.

The fastener 300 illustrated in FIG. 14 may be similar to the fastener 100. For example, the fastener 300 may include a curved camming portion 350, a plunger portion 340, and biasing portion 370 similar to the curved camming portion 150, the plunger portion 140, and the biasing portion 170 of the fastener 100. The fastener 300, however, has some structurally differences in the housing portion, flange portion, and level portion as compared to the fastener 100. Functionally, however, the fastener 300 functions is the same manner as the fastener 100.

The fastener 400 illustrated in FIG. 15, in some embodiments, may include an operating portion 439 having a pull plunger portion 440, rather than a camming portion (e.g., camming portion 150 of the fastener 100) that relies on the biasing portion 470 to maintain the plunger portion 440 in an actuated position. For example, the biasing portion 470 may be structurally configured to be in an expanded state (i.e., similar to the state of biasing portion 170 when axially compressed) when unacted upon. Thus, the expanded state is the natural state of the biasing portion 470.

The pull plunger portion 440 may be received within a housing portion 454 and have a distal end portion 456 coupled to the biasing portion 470 and a proximal end portion 457 having a manually engageable portion 458 (e.g., enlarged head portion). To insert the fastener 400 into a bore (not shown) (e.g., screw boss of an enclosure) the pull plunger portion 440 may be moved axially relative to the housing portion 454 to move the biasing portion 470 to a unexpanded state (e.g., stretch the biasing member to narrow it). Once inserted into the bore, the pull plunger portion 440 may be released to allow the biasing portion 470 to return to the expanded state to secure an electronic component to an enclosure.

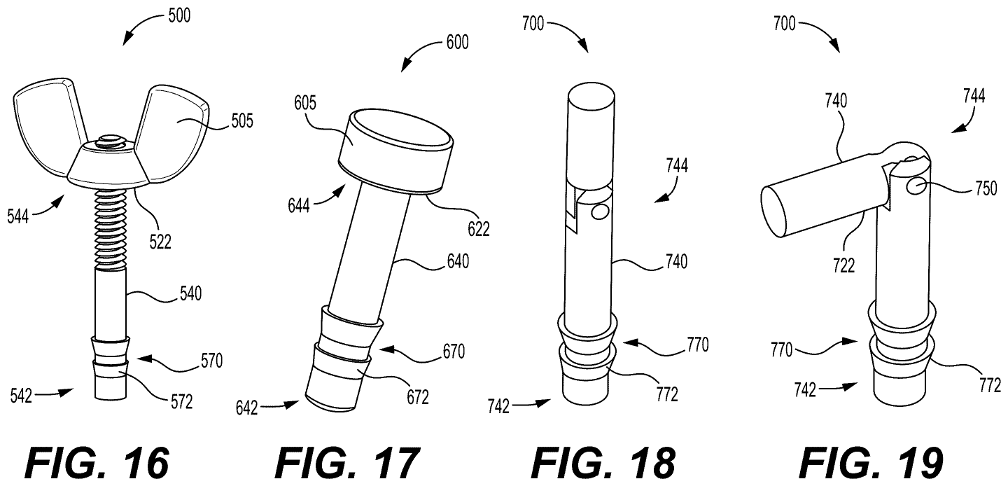

FIGS. 16-19 illustrate alternative embodiments of fasteners 500, 600, 700 structurally configured to be pushed into the receiving portion (e.g., receiving portion 192, such as a screw boss) to couple an electronic component to an enclosure (e.g., the electronic component 180 to the enclosure 190). In some embodiments, the fasteners 500, 600, 700 may include plunger portions 540, 640, 740 having a distal end portions 542, 642, 742 and a proximal end portions 544, 644, 744 opposite the distal end portions 542, 642, 742. In some embodiments, the plunger portions 540, 640, 740 may include biasing portions 570, 670, 770 at, or adjacent, the distal end portions 542, 642, 742. The biasing portions 570, 670, 770 may be structurally configured to biasingly engage a wall (e.g., inner wall 194) of the receiving portion 192 of the enclosure 190.

The biasing portions 570, 670, 770 may be configured in a variety of ways. Any structure capable of securing the fasteners 500, 600, 700 into the receiving portion 192 may be used. For example, in some embodiments, the biasing portions 570, 670, 770, may include compressible barbs 572, 672, 772. The biasing portions 570, 670, 770, may be structurally configured (e.g., angled or tapered) to allow the biasing portions 570, 670, 770 to be readily inserted into the receiving portion 192 (e.g., a bore) while resisting removal from the receiving portion 192.

The plunger portions 540, 640, 740 and the biasing portions 570, 670, 770 may be pushed through the electronic component 180 and into the receiving portion 192 of the enclosure 190 to secure the electronic component in place. In some embodiments, the fasteners 500, 600, 700 may include an engagement surface portions 522, 622, 722 at, or adjacent, the proximal end portions 544, 644, 744. The engagement surface portions 522, 622, 722 may be structurally configured to engage a mounting surface portion an electronic component (e.g., the mounting surface portion 184 of the mounting portion 182 of the electronic component 180) to secure the electronic component to the enclosure. For example, as shown in FIG. 16, in some embodiments, the fastener 500 may include a wing nut 505, or other threaded structure, having the engagement surface portion 522 that can be used to secure the electronic component 180 to the enclosure 190. As shown in FIG. 17, in some embodiments, the fastener 600 may include a stop portion 605 (e.g., a head portion) at the proximal end portion 644 that includes the engagement surface portion 622. In some embodiments, the stop portion 605 may be fixed to or attached to the proximal end portion 644. The stop portion 605 may be sized larger than a bore of the electronic component (e.g., the bore 186 of the electronic component 180) through which the plunger portion 640 is received. Thus, the stop portion 605 helps secure the electronic component to the enclosure and prevents the electronic component from being removed from the fastener 600.

As shown in FIG. 19, in some embodiments, the fastener 700 may include a pivoting plunger portion 740 that may be structurally configured to secure the electronic component 180 to the enclosure 190. The pivoting plunger portion 740 may be pivotally coupled to the proximal end portion 744 by, for example, a pivot connection 750. In some embodiments, the pivoting plunger portion 740 may be structurally configured to pivot (e.g., manually) from an unactuated position, as shown in FIG. 18, to an actuated position, as shown in FIG. 19. In some embodiments, the pivoting plunger portion 740 may pivot 80 to 100 degrees, or 90 degrees, from the unactuated position to the actuated position.

In the unactuated position, the electronic component may be removed from the fastener 700 since the bore of the electronic component (e.g., the bore 186 of the electronic component 180) may be larger than a diameter of the pivoting plunger portion 740. In the actuated position, the pivoting plunger portion 740 acts as the engagement surface portion 722 to secure the electronic component to the enclosure and prevent the electronic component from being removed from the fastener 700.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fastener structurally configured to secure an electronic component in an enclosure without using tools during installation, comprising:
a housing portion including a flange portion and a plunger receiving portion;
an actuating portion coupled with the housing portion;
wherein the flange portion includes an engagement surface portion structurally configured to engage a mounting surface portion of an electronic component;
wherein the actuating portion includes a plunger portion slidingly received in the plunger receiving portion;
wherein the plunger portion has a distal end portion extending out from the plunger receiving portion and a proximal end portion opposite the distal end portion;
wherein the actuating portion includes a camming portion pivotally coupled with the proximal end portion of the plunger portion;
wherein the distal end portion of the plunger portion includes a flanged portion having a cross sectional dimension greater than a cross sectional dimension of the plunger receiving portion;
wherein the actuating portion includes a biasing portion received on the plunger portion between the flanged portion of the distal end portion of the plunger portion and a distal end portion of the plunger receiving portion;
wherein the biasing portion has a larger cross sectional dimension than a cross sectional dimension of a passage of the plunger receiving portion such that the biasing portion is prevented from entering the passage;
wherein the biasing portion is configured to be positioned between a biasing portion engaging surface of the plunger receiving portion and a biasing portion engaging surface of the plunger portion;
wherein the biasing portion is structurally configured to be compressed in an axial direction between the biasing portion engaging surface of the plunger receiving portion and the biasing portion engaging surface of the plunger portion such that the biasing portion expands in a radially outward direction;
wherein the camming portion is configured to be pivotally coupled with the plunger portion at a pivot portion;
wherein the camming portion is structurally configured to be moved between a first position and a second position; and
wherein the camming portion includes a camming surface portion configured to engage a cam engaging surface portion of the plunger receiving portion such that when the camming portion moves from the first position to the second position, an engagement between the camming surface portion and the cam engaging surface portion of the plunger receiving portion results in relative sliding movement between the plunger portion and the plunger receiving portion of the housing portion such that the biasing portion is axially compressed and radially expanded so as to secure an electronic component in an enclosure and provide enhanced installation efficiency and simplicity.

2. The fastener of claim 1, wherein the camming portion includes a retaining portion structurally configured to retain the camming portion in the first position and the second position.

3. The fastener of claim 2, wherein the retaining portion includes a first grooved surface portion configured to receive the plunger portion when the camming portion is in the first position such that a user is required to apply a force to remove the plunger portion from the first grooved surface portion in order to move the camming portion out of the first position; and
wherein the retaining portion includes a second grooved surface portion configured to receive the plunger portion when the camming portion is in the second position such that a user is required to apply a force to remove the plunger portion from the second grooved surface portion in order to move the camming portion out of the second position.

4. The fastener of claim 1, wherein the camming portion includes a lever portion structurally configured to be manually actuated to pivot the camming portion.

5. A fastener structurally configured to secure an electronic component in an enclosure without using tools during installation, comprising:
a housing portion including an engagement surface portion and a plunger receiving portion;
a plunger portion slidingly received in the plunger receiving portion, the plunger portion having a distal end portion and a proximal end portion opposite the distal end portion;
a biasing portion received on the distal end portion of the plunger portion; and
a camming portion pivotally coupled with the proximal end portion of the plunger portion to pivot between a first position and a second position;
wherein the engagement surface portion is structurally configured to engage an electronic component to secure the electronic component to an enclosure;
wherein the biasing portion is structurally configured to be compressed in an axial direction between the plunger receiving portion and a biasing portion engaging surface at the distal end portion of the plunger portion such that the biasing portion expands in a radially outward direction; and
wherein the camming portion includes a camming surface portion configured to engage a cam engaging surface portion of the plunger receiving portion such that when the camming portion moves from the first position to the second position, an engagement between the camming surface portion and the cam engaging surface portion of the plunger receiving portion results in relative movement between the plunger portion relative to the plunger receiving portion such that the biasing portion is axially compressed and radially expanded so as to secure an electronic component in an enclosure and provide enhanced installation efficiency and simplicity.

6. The fastener of claim 5, wherein the camming portion includes a lever portion structurally configured to be manually actuated to pivot the camming portion.

7. The fastener of claim 5, further including a retaining portion structurally configured to retain the camming portion in the first position and the second position.

8. The fastener of claim 7, wherein the retaining portion includes a first grooved surface portion configured to receive the plunger portion when the camming portion is in the first position such that a user is required to apply a force to remove the plunger portion from the first grooved surface portion in order to move the camming portion out of the first position; and
wherein the retaining portion includes a second grooved surface portion configured to receive the plunger portion when the camming portion is in the second position such that a user is required to apply a force to remove the plunger portion from the second grooved surface portion in order to move the camming portion out of the second position.

9. The fastener of claim 5, wherein the distal end portion of the plunger portion includes a flanged portion having a cross-sectional dimension greater than a cross sectional dimension of the plunger receiving portion.

10. The fastener of claim 9, wherein the biasing portion is received in the plunger portion between the flanged portion and the plunger receiving portion.

11. A fastener structurally configured to secure an electronic component in an enclosure without using tools during installation, comprising:
a housing portion including an engagement surface portion and a plunger receiving portion;
a plunger portion configured to be received in the plunger receiving portion;
a biasing portion configured to be received on a distal end portion of the plunger portion; and
an operating portion configured to be coupled with the plunger portion;
wherein the engagement surface portion is structurally configured to engage an electronic component to secure the electronic component to an enclosure;
wherein the biasing portion is structurally configured to be compressed in an axial direction between the plunger receiving portion and a biasing portion engaging surface at the distal end portion of the plunger portion such that the biasing portion expands in a radially outward direction; and
wherein movement of the operating portion from a first position to a second position results in relative movement between the plunger portion and the plunger receiving portion such that the biasing portion is axially compressed and radially expanded so as to secure an electronic component in the enclosure and provide enhanced installation efficiency and simplicity.

12. The fastener of claim 11, wherein the operating portion includes a camming portion pivotally coupled with a proximal end portion of the plunger portion to pivot between the first position and the second position.

13. The fastener of claim 12, wherein the camming portion includes a camming surface portion configured to engage a cam engaging surface portion of the plunger receiving portion such that when the camming portion moves from the first position to the second position, an engagement between the camming surface portion and the cam engaging surface portion of the plunger receiving portion results in relative the movement between the plunger portion relative to the plunger receiving portion.

14. The fastener of claim 12, wherein the camming portion includes a lever portion structurally configured to be manually actuated to pivot the camming portion.

15. The fastener of claim 11, wherein the operating portion includes a first ramped portion fixed relative to the housing portion and a second ramped portion fixed relative to the plunger portion.

16. The fastener of claim 15, wherein rotation of the first ramped portion relative to the second ramped portion moves the plunger portion to radially compress the biasing portion.

17. The fastener of claim 11, further including a retaining portion structurally configured to retain the operating portion in the first position and in the second position.

18. The fastener of claim 11, wherein the distal end portion of the plunger portion includes a flanged portion having a cross sectional dimension greater than a cross sectional dimension of the plunger receiving portion.

19. The fastener of claim 18, wherein the biasing portion is received in the plunger portion between the flanged portion and the plunger receiving portion.

20. The fastener of claim 11, wherein the biasing portion has a larger cross sectional dimension than a cross sectional dimension of a passage of the plunger receiving portion such that the biasing portion is prevented from entering the passage.
